(19) United States
(12) Patent Application Publication
(10) Pub. No.: US 2019/0071625 A1
(43) Pub. Date: Mar. 7, 2019

(54) APPARATUS AND METHOD FOR EVENLY STORING AND DISTRIBUTING EQUIVALENT AMOUNTS OF A SOLUTION PERTAINING TO A FOOD OR LIQUID

(71) Applicant: Jacqueline Marie Carson, Slippery Rock, PA (US)

(72) Inventor: Jacqueline Marie Carson, Slippery Rock, PA (US)

(21) Appl. No.: 16/178,207

(22) Filed: Nov. 1, 2018

Related U.S. Application Data
(63) Continuation-in-part of application No. 15/017,590, filed on Feb. 6, 2016.

(51) Int. Cl. C12G 3/06; B65D 71/42; B65D 85/72; C12G 3/00

(52) U.S. Cl. CPC C12G 3/06; C12G 3/005; B65D 85/72; B65D 71/42

(57) ABSTRACT

An alcoholic beverage including a solution for aiding in the consumption of the alcoholic beverage including sucralose, sodium citrate, and a gelling agent. The solution is adapted to reduce the feeling of alcohol burn within the mouth and throat of a person consuming the alcoholic beverage.

### CROSS-REFERENCE TO RELATED APPLICATION

The present application is related to and claims priority from prior provisional application Ser. No. 15/017,590, filed Feb. 6, 2016 which is incorporated herein by reference.

### FIELD OF THE INVENTION

The presently disclosed embodiments are related, in general, to a container for food or liquid. More particularly, the presently disclosed embodiments are related to an apparatus and method for evenly storing and distributing equivalent amounts of a solution pertaining to a food or liquid.

### BACKGROUND OF THE INVENTION

A JELL-O shot is a portion of JELL-O mixed with a type of alcohol. These shots generally contain a very high level of alcohol. Swallowing chunks of this JELL-O is an entertaining way of ingesting a generous amount of alcohol. These products are generally used at parties or other events where people are celebrating.

There is a need of an apparatus and method to provide storage and a distribution system for the gelatin or pudding solutions used for these JELL-O shots.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

An apparatus and a method for evenly storing and distributing equivalent amounts of a solution pertaining to a food or liquid are provided substantially as shown in, and/or described in connection with, at least one of the figures.

According to embodiments illustrated herein, there is provided an apparatus for evenly storing and distributing equivalent amounts of a solution pertaining to a food or liquid.

The apparatus includes a plurality of compartments and a closing sheet. The plurality of compartments spaced at pre-defined intervals adapted to receive the solution of the food. In one embodiment, the plurality of compartments has a closed bottom end and an insert top end.

The closing sheet to cover the plurality of compartments from the insert top end in order to preserve the solution of the food. In one embodiment, the closing sheet has plurality of seal mark space at pre-defined intervals. In one embodiment, the plurality of compartments is made of high density polyethylene.

In one embodiment, the solution pertaining to the food is at least one of: gelatin dessert; and/or pudding shot. In one embodiment, the covering sheet receives a machine seal in order to get glued with the plurality of compartments.

According to embodiments illustrated herein there is provided a method for evenly storing and distributing equivalent amounts of a solution pertaining to a food or liquid. The method includes the step of receiving the solution of the food or liquid through a plurality of compartments spaced at pre-defined intervals adapted. In one embodiment, the plurality of compartments has a closed bottom end and an insert top end.

Then the method includes the step of covering the plurality of compartments from the insert top end in order to preserve the solution of the food or liquid through a closing sheet, wherein the closing sheet has plurality of seal mark space at pre-defined intervals.

Then, the method includes the step of receiving a machine seal over the covering sheet in order to get glued with the plurality of compartments.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of arrangements, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates an apparatus for evenly storing and distributing equivalent amounts of a solution pertaining to a food or liquid, in accordance with at least one embodiment;

FIG. 2 illustrates a top view of the apparatus for evenly storing and distributing equivalent amounts of a solution pertaining to a food or liquid, in accordance with at least one embodiment; and

FIG. 3 illustrates a flowchart of a method for evenly storing and distributing equivalent amounts of a solution pertaining to a food or liquid, in accordance with at least one embodiment.

FIG. 4 illustrates a flowchart of the ingredients in the improved alcoholic beverage including the solution for aiding in the consumption of the alcoholic beverage according to the preferred embodiment of the present invention.

### DETAILED DESCRIPTION OF THE DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

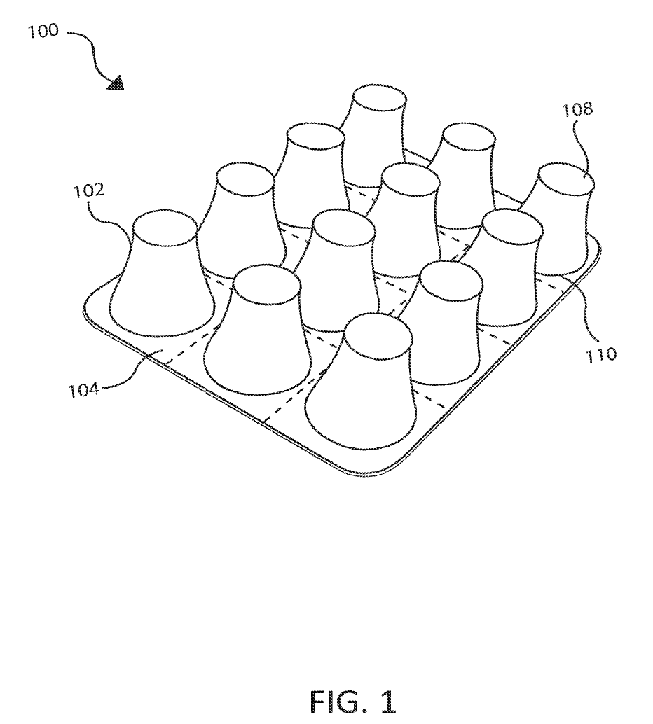

FIG. 1 illustrates an apparatus 100 for evenly storing and distributing equivalent amounts of a solution pertaining to a food or liquid, in accordance with at least one embodiment. The apparatus 100 includes a plurality of compartments 102 and a closing sheet 104. The plurality of compartments 102 spaced at pre-defined intervals adapted to receive the solution of the food or liquid. In one embodiment, the plurality of compartments 102 has a closed bottom end 108 and an insert top end 110.

In one embodiment, the plurality of compartments 102 is made of high density polyethylene (HDPE). Examples of the high density polyethylene includes but not limited to food grade plastic or polyethylene high-density (PEHD). In one embodiment, the solution pertaining to the food is selected from at least one of gelatin dessert; and pudding shot. Gelatin is a protein obtained by boiling skin, tendons, ligaments, and/or bones with water. Pudding is a type of food that may be either a dessert or a savory dish.

The plurality of compartments 102 may be of has various shapes and sizes such as includes but not limited to cylindrical, conical, curved and square etc. For an exemplary purpose FIG. 1 shows twelve compartments 102. However the number of compartments 102 may varies within the scope of invention. The plurality of compartments 102 may break apart from each other.

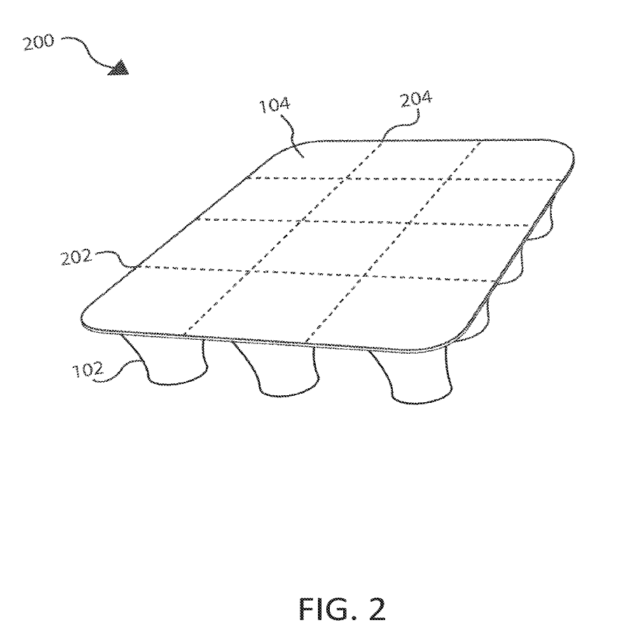

FIG. 2 illustrates a top view 200 of the apparatus for evenly storing and distributing equivalent amounts of a solution pertaining to a food or liquid, in accordance with at least one embodiment. The closing sheet 104 covers the plurality of compartments 102 from the insert top end 110 (as shown in the FIG. 1) in order to preserve the solution pertaining the food or liquid. In one embodiment, the closing sheet 104 has plurality of seal mark 202, and 204 spaced at pre-defined intervals. The seal marks 202 and 204 enable the plurality of compartments 102 to break apart from each other. In one embodiment, the covering sheet 104 receives a machine seal in order to get glued with the plurality of compartments 102.

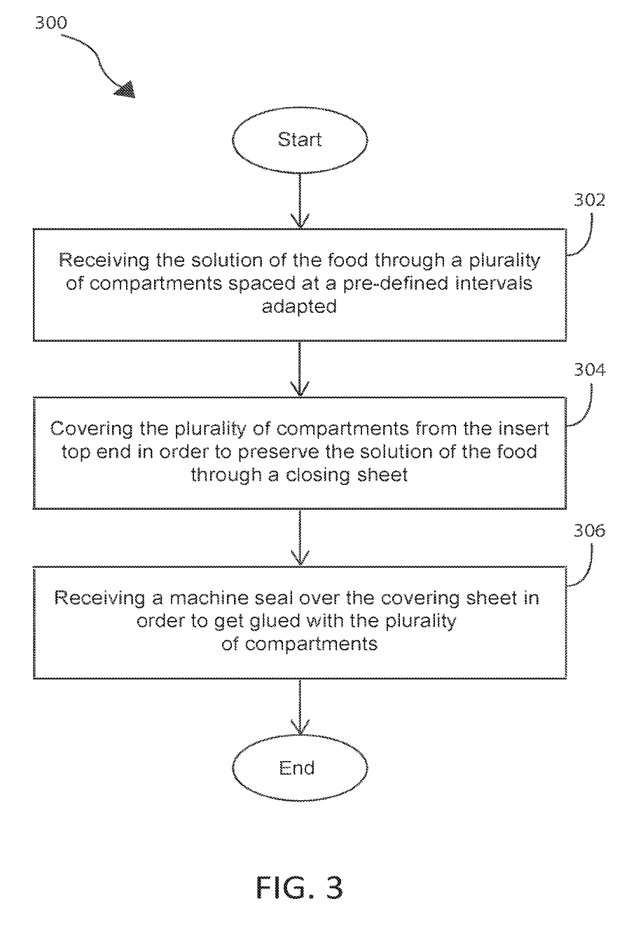

FIG. 3 illustrates a flow chart of a method 300 for evenly storing and distributing equivalent amounts of a solution pertaining to a food or liquid, in accordance with at least one embodiment. The method 300 of the present invention initiates with a step of 302 of receiving the solution of the food or liquid through a plurality of compartments spaced at pre-defined intervals adapted. In one embodiment, the plurality of compartments has a closed bottom end and an insert top end.

The step 302 is then followed by a step 304 of covering the plurality of compartments from the insert top end in order to preserve the solution of the food or liquid through a closing sheet, wherein the closing sheet has plurality of seal mark space at pre-defined intervals. The step 302 is then followed by a step 304 of receiving a machine seal over the covering sheet in order to get glued with the plurality of compartments.

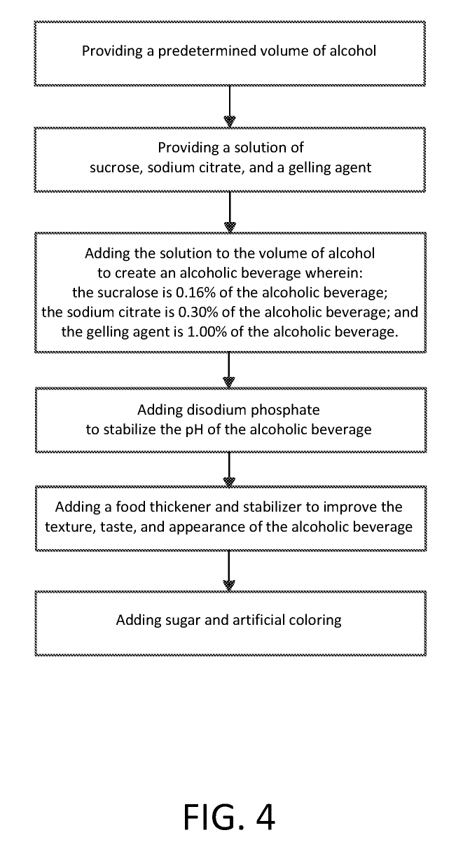

In the preferred embodiment, as illustrated in FIG. 4, the improved alcoholic beverage comprises alcohol and a solution for aiding in the consumption of the alcohol, wherein the solution includes sucralose; sodium citrate; and a gelling agent, wherein the solution is adapted to reduce the feeling of alcohol burn within the mouth and throat of a person consuming the improved alcoholic beverage.

The solution may further include disodium phosphate adapted to stabilize the pH of the solution; a food thickener and stabilizer adapted to improve the texture, taste, and appearance of said solution; sugar; and artificial coloring.

In the preferred embodiment, as illustrated in FIG. 4, the percentage of sucralose is 0.16% of the improved alcoholic beverage; the percentage of sodium citrate is 0.30% of the improved alcoholic beverage; and the gelling agent is 1.00% of the improved alcoholic beverage.

Known names of gelling agents that can be incorporated into the preferred embodiment of the improved alcoholic beverage includes TICAGEL 212; GARRAGEENAN E407; AGAR, also known as AGAR-AGAR.

Disodium Phosphate and Sodium Citrate are needed to stabilize the pH of the solution. Sodium citrate also adds another shot of tartness and some saltiness to round out the flavor—think of the tang of club soda or Sprite, where it's a key ingredient. Molecular gastronomists use it in one of their culinary parlor tricks to “spherify” beverages. Carrageenan E407 is a food thickener that can be used in food as a stabilizer and thickener. Carrageenan is used to improve the texture, taste, and appearance of many foods. The use of carrageenan in candy popular in China. Carrageenan made candy has a strong fruit aroma, a moderate sweetness, and a refreshing non-stick tooth. It is also more transparent than agar agar and has a lower price than agar agar. It is added to hard and soft candies in general. It Can make the product taste smooth, more flexible, low viscosity, increased stability. Food grade carrageenan has been independently evaluated by the Joint FAO*/WHO* Expert Committee on Food Additives (JECFA), an international panel of expert toxicologists who review data and develop recommendations about food ingredients. JECFA determined that food grade carrageenan was a safe food additive with no limits on its use in food. Agar is a gelling agent, used in industry in lieu of gelatin in products such as jellies, candies, cheeses, and glazes. Since agar is vegetarian, it's a good substitute in dishes that traditionally call for gelatin, which is derived from animal skins and bones. Agar has a slight taste, though, so it works best with strongly flavored dishes. Sometimes called agar-agar—is perhaps the oldest of all the food additives commonly used in industry, but has only recently become known in western cuisines, mostly as a vegetarian substitute for gelatin. One advantage to using agar-agar over gelatin is that it stays firm even when it's warm. (Probably why our premade gelatin shots don't require refrigeration.) Sucralose is an artificial sweetener and sugar substitute. The majority of ingested sucralose is not broken down by the body, so it is noncaloric. In the European Union, it is also known under the E number E955. Sucralose is 600 times sweeter than sugar, and it can be used in place of or combined with sugar in cooking and baking. Sucralose has been studied extensively and has been found to be safe by experts and researchers around the world.

The following is how ingredients are used to flavor known JELLO:
Sugar—Gelatin is colorless, odorless, and flavorless, so most of the other ingredients are here to fix that. According to the “Nutrition Facts” on the box JELL-O powder is 90 percent sugar by weight.
Artficial Flavors—Taste is a crude sense—your tongue perceives only five different values. So to evoke specific fruit flavors, chemists rely on volatile esters that send subtler hints to your nose. KRAFT won't say what it deceives our taste buds with, but some usual suspects are octyl acetate for orange flavor, methyl anthranilate for grape, and ethyl methylphenylglycidate to whisper strawberry.
Artificial Colors—Cheap petroleum-based dyes make for intense shock-and-awe hues. They're also more stable than natural colors, which matters in a product that might sit on your shelf for years. Strawberry Jell-O uses the disodium salt of 6-hydroxy-5-[(2-methoxy-5-methyl-4-sulfophenyl)azo]-2-naphthalenesulfonic acid—aka Red 40.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope.

What is claimed is:

1. A solution for aiding in the consumption of alcoholic beverages, wherein said solution includes:
sucralose;
sodium citrate; and
a gelling agent;
wherein said solution is adapted to reduce the feeling of alcohol burn within the mouth and throat of a person consuming an alcoholic beverage mixed with said solution.

2. The solution of claim 1, further including disodium phosphate adapted to stabilize the pH of said solution.

3. The solution of claim 1, further including food thickener and stabilizer adapted to improve the texture, taste, and appearance of said solution.

4. The solution of claim 1, further including sugar.

5. The solution of claim 1, further including an artificial coloring.

6. The solution of claim 1, wherein
said sucralose is 0.16% of said alcoholic beverage;
said sodium citrate is 0.30% of said alcoholic beverage; and
said gelling agent is 1.00% of said alcoholic beverage.

7. The solution of claim 1, wherein said gelling agent is TICAGEL 212.

8. The solution of claim 1, wherein said gelling agent is GARRAGEENAN E407.

9. The solution of claim 1, wherein said gelling agent is AGAR.

10. An improved alcoholic beverage comprising:
alcohol; and
a solution for aiding in the consumption of said alcohol, wherein said solution includes:
sucralose;
sodium citrate; and
a gelling agent;
wherein said solution is adapted to reduce the feeling of alcohol burn within the mouth and throat of a person consuming said improved alcoholic beverage.

11. The improved alcoholic beverage of claim 10, wherein said solution further includes disodium phosphate adapted to stabilize the pH of said solution.

12. The improved alcoholic beverage of claim 10, wherein said solution further includes food thickener and stabilizer adapted to improve the texture, taste, and appearance of said solution.

13. The improved alcoholic beverage of claim 10, wherein said solution further includes sugar.

14. The improved alcoholic beverage of claim 10, wherein said solution further includes artificial coloring.

15. The improved alcoholic beverage of claim 10, wherein:
said sucralose is 0.16% of said improved alcoholic beverage;
said sodium citrate is 0.30% of said improved alcoholic beverage; and
said gelling agent is 1.00% of said improved alcoholic beverage.

16. The improved alcoholic beverage of claim 10, wherein said gelling agent is TICAGEL 212.

17. The improved alcoholic beverage of claim 10, wherein said gelling agent is GARRAGEENAN E407.

18. The improved alcoholic beverage of claim 10, wherein said gelling agent is AGAR.
